(19) United States
(12) Patent Application Publication
(10) Pub. No.: US 2026/0259314 A1
(43) Pub. Date: Sep. 3, 2026

(54) POSITIONING SYSTEM AND METHOD, AND STORAGE MEDIUM

(71) Applicant: UbiTraq Technology Co., Ltd., Beijing (CN)

(72) Inventors: Yanxing DU, Beijing (CN); Yang LI, Beijing (CN)

(73) Assignee: UbiTraq Technology Co., Ltd., Beijing (CN)

(21) Appl. No.: 18/995,776

(22) PCT Filed: Mar. 28, 2023
(86) PCT No.: PCT/CN2023/084329

§ 371 Date: Jan. 16, 2025

(30) Foreign Application Priority Data
Jul. 26, 2022 (CN) 202210881464.2

(51) Int. Cl. G01S 13/76

(52) U.S. Cl. CPC G01S 13/76

(57) ABSTRACT

The embodiments of the present invention provide a positioning system and method, and a storage medium. The positioning system comprises at least one base station and a device, which is provided with an ultra wideband (UWB) label, wherein the device is used for sending a UWB signal; each base station in the at least one base station is used for receiving the UWB signal and determining orientation parameters of the device and each base station according to the UWB signal; and the device is positioned on the basis of the orientation parameters and the distance between the device and each base station.

### CROSS-REFERENCE TO RELATED APPLICATION

This application is based on and claims the Chinese patent application No. 202210881464.2, filed on Jul. 26, 2022. The entire content of the Chinese patent application is hereby incorporated into this application by reference.

### TECHNICAL FIELD

The present disclosure relates to the technical field of positioning, in particular to a positioning system and method, and a storage medium.

### BACKGROUND

In related technologies, an ultra wideband (UWB) positioning system requires at least three anchors for performing positioning, which results in a problem of high cost and complex deployment in the method. At present, there is no effective solution to this problem.

### SUMMARY

To solve the existing technical problems, the embodiments of the present disclosure provide a positioning system and method, and a storage medium.

The technical solution of the embodiments of the present disclosure is implemented as follows for solving the above problems.

The embodiments of the present disclosure provide a positioning system, which includes at least one anchor, and a device provided with an ultra wideband (UWB) tag.

The device is configured to send a UWB signal.

Each of the at least one anchor is configured to receive the UWB signal, determine an orientation parameter of the device and the anchor according to the UWB signal, and position the device based on the orientation parameter and a distance between the device and the anchor.

In the above system, the orientation parameter comprises a first angle and/or a second angle. Each of the at least one anchor includes a UWB antenna array, a UWB signal phase discriminator and a processor, and each of the UWB antenna array and the processor is connected to the UWB signal phase discriminator.

The UWB antenna array is configured to receive the UWB signal.

The UWB signal phase discriminator is configured to determine a phase parameter of the UWB antenna array based on the UWB signal.

The processor is configured to determine the first angle and/or the second angle of the device and the anchor based on the phase parameter, and determine coordinates of the device based on the first angle and/or the second angle and the distance between the device and the anchor.

In the above system, the UWB antenna array includes at least three antenna elements. The three antenna elements are not arranged on the same straight line, and each antenna element of the at least three antenna elements is connected to the UWB signal phase discriminator.

Each antenna element is configured to receive the UWB signal.

The UWB signal phase discriminator is further configured to determine an observation vector of the at least three antenna elements based on the UWB signal. An element in the observation vector represents a phase difference of the UWB signal received by every two antenna elements among the at least three antenna elements.

The processor is further configured to determine a theoretical azimuth corresponding to a vector having the highest matching degree with the observation vector based on the observation vector and a preset vector template, take the theoretical azimuth as the first angle, and/or determine the second angle based on the theoretical azimuth and a preset angle.

In the above system, for each of the at least one anchor, an XYZ coordinate system is established with taking the anchor as an origin and taking a normal of a shell surface of the anchor as Z-axis. The first angle is an angle between a projection of a distance between the device and the anchor onto an XOY plane in the XYZ coordinate system and X-axis, and the second angle is an angle between the distance between the device and the anchor and the Z-axis in the XYZ coordinate system.

In the above system, the coordinates of the device includes three-dimensional coordinates of the device.

The processor is further configured to determine the three-dimensional coordinates of the device based on the first angle, the second angle, and the distance between the device and the anchor.

In the above system, the coordinates of the device includes the two-dimensional coordinates of the device.

The processor is further configured to acquire a height difference between the anchor and the device, and determine the two-dimensional coordinates of the device based on the first angle, the height difference, and the distance between the device and the anchor.

In the above system, at least two of the spacings between any two of the three antenna elements are less than or equal to a half-wavelength of the UWB signal.

In the above system, the UWB signal phase discriminator is further configured to determine an angle at which each pair of at least two pairs of antenna elements receives the same UWB signal. The at least two pairs of antenna elements are composed of any two antenna elements among the at least three antenna elements.

The processor is further configured to determine the first angle and/or the second angle based on the angle and a position relationship between antenna elements in each pair of the antenna elements.

In the above system, the UWB signal phase discriminator is further configured to determine a phase difference of the same UWB signal received by each pair of antenna elements, and determine an angle at which each pair of antenna elements receives the same UWB signal based on the phase difference.

The embodiment of the present disclosure provides a positioning method applied to the above positioning system, which includes the following operations.

An ultra wideband (UWB) signal transmitted by a device provided with an UWB tag is received;

An orientation parameter of the device and an anchor is determined based on the UWB signal.

The device is positioned based on the orientation parameter and a distance between the device and the anchor.

In the above method, the orientation parameter includes a first angle and/or a second angle, and the operation that the orientation parameter of the device and the anchor is determined based on the UWB signal includes the following operations.

The first angle and/or the second angle of the device and the anchor are determined based on the UWB signal.

In the above method, the operation that the device is positioned based on the orientation parameter and the distance between the device and the anchor includes the following operation.

Coordinates of the device are determined based on the first angle and/or the second angle and the distance between the device and the anchor.

In the above method, the coordinates of the device include three-dimensional coordinates of the device, and the method further includes the following operation.

The three-dimensional coordinates of the device are determined based on the first angle, the second angle, and the distance between the device and the anchor.

In the above method, the coordinates of the device include two-dimensional coordinates of the device, and the method further includes the following operations.

A height difference between the device and the anchor is obtained, and the two-dimensional coordinates of the device are determined based on the first angle, the height difference, and the distance between the device and the anchor.

In the above method, the distance between the device and the anchor is determined based on a time of flight (TOF) corresponding to the UWB signal.

The embodiment of the present disclosure further provides a storage medium on which a computer program is stored. When the computer program is executed by a processor, the computer program implements any operation of the above method.

The embodiment of the present disclosure provides a positioning system and method, and a storage medium. The system includes at least one anchor and a device provided with an ultra wideband (UWB) tag. The device is configured to send a UWB signal, and each anchor in the at least one anchor is configured to receive the UWB signal, determine an orientation parameter of the device and the anchor according to the UWB signal, and position the device based on the orientation parameter and a distance between the device and the anchor. With the technical solution of the embodiment of the present disclosure, each anchor of the at least one anchor receives the UWB signal sent by the device provided with the UWB tag, determines the orientation parameter of the device and the anchor according to the UWB signal, and positions the device based on the orientation parameter and the distance between the device and the anchor, thereby realizing accurate positioning and reducing the number and cost of anchors.

### BRIEF DESCRIPTION OF THE DRAWINGS

FIG. 1 is a schematic deployment diagram of an anchor for positioning a vehicle key provided in related technology.

FIG. 2 is a schematic diagram of a positioning system provided in an embodiment of the present disclosure.

FIG. 3 is a schematic diagram of a positioning system for a UWB vehicle key in an embodiment of the present disclosure.

FIG. 4 is a schematic structural diagram of an anchor in an embodiment of the present disclosure.

FIG. 5 is a schematic diagram of a three-dimensional coordinate system established between the anchor and the device in an embodiment of the present disclosure.

FIG. 6 is another schematic structural diagram of an anchor in an embodiment of the present disclosure.

FIG. 7 is a schematic implementation flowchart of a positioning method in an embodiment of the present disclosure.

FIG. 8 is a schematic diagram of ranging through a UWB signal in an embodiment of the present disclosure.

### DETAILED DESCRIPTION

To make the objectives, technical solutions, and advantages of the embodiments of the present disclosure clearer, the specific technical solutions of the present disclosure are further described in detail below with reference to the accompanying drawings in the embodiments of the present disclosure. The following embodiments are used to illustrate the embodiments of the present disclosure, rather than limiting the scope of the embodiments of the present disclosure.

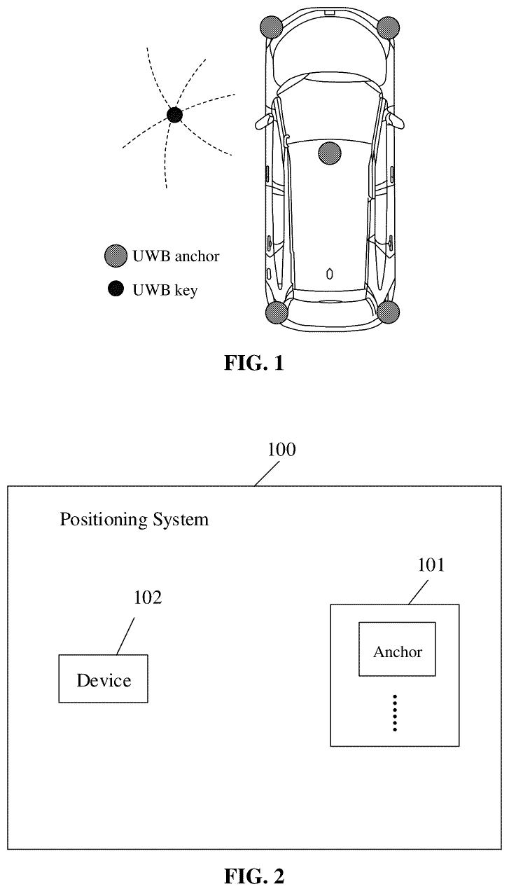

In related technologies, at least three anchors are required for positioning in an ultra wideband (UWB) positioning system. For example, when positioning a vehicle key, five traditional UWB anchors (four outside the vehicle and one inside the vehicle) need to be installed on the vehicle, as shown in FIG. 1. FIG. 1 is a schematic deployment diagram of anchors for positioning a vehicle key provided in related technology. The four anchors are installed at the four corners of the front and rear fenders outside the vehicle, and one is installed inside the vehicle. This method has the following disadvantages.
(1) This method is high cost and complex deployment.
(2) This method may only determine a relative position of the key outside the vehicle and detect whether the key is inside the vehicle, but cannot accurately position the position of the key inside the vehicle.

The embodiment of the present disclosure provides a positioning system. FIG. 2 is a schematic diagram of a positioning system provided in an embodiment of the present disclosure. As shown in FIG. 2, the system 100 includes at least one anchor 101 and a device 102 provided with an UWB tag.

The device 102 is configured to transmit a UWB signal.

Each of the at least one anchor 101 is configured to receive the UWB signal, determine an orientation parameter of the device and the anchor according to the UWB signal, and position the device 102 based on the orientation parameter and a distance between the device 102 and the anchor 101.

It should be noted that the device 102 may be determined according to the actual situation, which is not limited herein. As an example, the device 102 may be a network device, a terminal device, a handheld device, etc. In practical applications, the device 102 may be a physical key or a mobile phone. The physical key may be a vehicle key.

An arrangement position of the at least one anchor 101 may be determined according to the actual situation, which is not limited herein. As an example, the at least one anchor 101 may be arranged on the vehicle. Specifically, at least one anchor 101 may be described to be arranged on the vehicle. The number of the at least one anchor 101 may be determined according to the actual situation, which is not limited herein. As an example, the number of the at least one anchor 101 may be one, two, or more. In practical applications, the anchor 101 may be an ultra wideband-angle of arrival (UWB-AOA) anchor. Assuming that the at least one anchor 101 is arranged on the vehicle, the one anchor 101 may be called as a single UWB-AOA anchor. The single UWB-AOA anchor may be used to determine an accurate position of the vehicle key inside and outside the vehicle, and the measurement effect is good. Two or more anchors 101 may be used to reduce blind areas of signal coverage. The anchor 101 may be arranged at the vicinity of the vehicle sunroof controller, the vicinity of the inside rearview mirror, the vicinity of the front and rear reading lights, etc.

The number of UWB tags in the device 102 may be determined according to the actual situation, which is not limited herein. As an example, the number of UWB tags may be one or more. The UWB tag in the device 102 may send the UWB signal.

The orientation parameter may be determined according to the actual situation, which are not limited herein. As an example, the orientation parameter may be regarded as a stereoscopic or planar projection direction. In practical applications, each anchor 101 in the at least one anchor may receive the UWB signal, and measure the stereoscopic or planar projection direction of the device and the anchor by using the UWB signal.

For each anchor 101, the distance between the device 102 and the anchor 101 may be determined according to the actual situation, which is not limited herein. As an example, the distance between the device 102 and the anchor 101 may be determined based on the time of flight (TOF).

The operation that the device 102 is positioned based on the orientation parameter and the distance between the device 102 and the anchor 101 may include determining the coordinates of the device 102 based on the orientation parameter and the distance between the device and the anchor. The coordinates may include three-dimensional coordinates or two-dimensional coordinates.

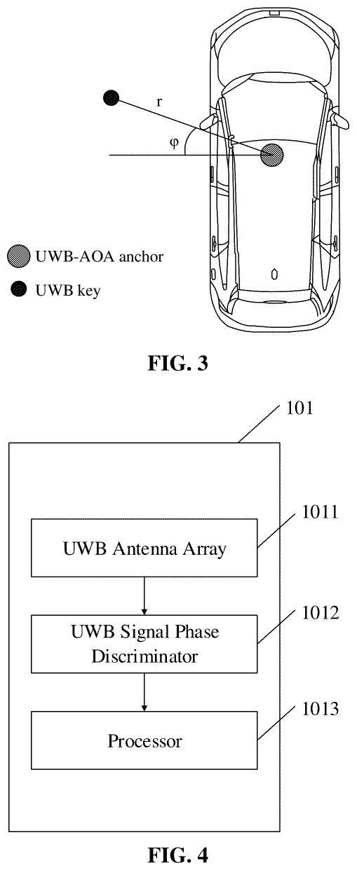

For convenience of understanding, as illustrated in the example, at least one anchor 101 is a UWB-AOA anchor arranged on the vehicle, and the device 102 is a UWB key. As shown in FIG. 3, FIG. 3 is a schematic diagram of a positioning system for a UWB vehicle key in an embodiment of the present disclosure, where r represents the distance between the UWB-AOA anchor and the UWB vehicle key, and φ represents the orientation parameter.

In practical applications, the UWB-AOA anchor may measure the stereoscopic or planar projection direction in which the device 102 provided with a UWB tag sends the UWB signal, and measure a distance from the UWB-AOA anchor to the device provided with the UWB tag by the TOF. A single UWB-AOA anchor may determine a relative stereoscopic or planar projection position of the device provided with the UWB tag. The number of anchors may be reduced from 5 to 1, which greatly reduces the cost and is more conducive to be popularized to the mid-end vehicle and the low-end vehicle. In this way, the number of components on the vehicle is reduced, the wiring harness in vehicle is simplified, and the system complexity is reduced.

In an optional embodiment of the present disclosure, as shown in FIG. 4, FIG. 4 is a schematic structural diagram of an anchor in an embodiment of the present disclosure. The orientation parameter includes a first angle and/or a second angle. Each anchor 101 includes a UWB antenna array 1011, a UWB signal phase discriminator 1012 and a processor 1013. Each of the UWB antenna array 1011 and the processor 1013 is connected to the UWB signal phase discriminator 1012.

The UWB antenna array 1011 is configured to receive the UWB signal.

The UWB signal phase discriminator 1012 is configured to determine a phase parameter of the UWB antenna array 1011 based on the UWB signal.

The processor 1013 is configured to: determine the first angle and/or the second angle of the device 102 and the anchor 101 based on the phase parameter, and determine coordinates of the device 102 based on the first angle and/or the second angle and the distance between the device 102 and the anchor 101.

It should be noted that the processor 1013 may be any processor, which is not limited herein. As an example, the processor 1013 may be a central processing unit (CPU).

The first angle may be denoted as φ, which is also referred to as an azimuth angle. The first angle may represent an angle formed by a planar projection of the distance between the device 102 and the anchor. The second angle may be denoted as θ, which is also referred to as the pitch angle. The second angle may represent an angle between the distance between the device 102 and the anchor 101 and the normal of a shell surface of the anchor. In practical applications, the distance between the device 102 and the anchor may be regarded as a line connecting the device 102 and the anchor, the length of the line is the distance, and the line connecting the device 102 and the anchor may be denoted as OT, and the length of OT may be denoted as r.

In an optional embodiment of the present disclosure, the UWB antenna array 1011 comprises at least three antenna elements. The three antenna elements are not on the same straight line, and each antenna element of the at least three antenna elements is connected to the UWB signal phase discriminator.

Each antenna element is configured to receive the UWB signal.

The UWB signal phase discriminator 1012 is further configured to determine an observation vector corresponding to the at least three antenna elements based on the UWB signal. An element in the observation vector represents a phase difference of UWB signals received by every two antenna elements among the at least three antenna elements.

The processor 1013 is further configured to determine a theoretical azimuth corresponding to a vector having the highest matching degree with the observation vector based on the observation vector and a preset vector template, take the theoretical azimuth as the first angle; and/or determine the second angle based on the theoretical azimuth and a preset angle.

It should be noted that the three antenna elements include a first antenna element, a second antenna element and a third antenna element. For convenience of understanding, the first antenna element may be denoted as antenna A, the second antenna element may be denoted as antenna B, and the third antenna element may be denoted as antenna C. The three antenna elements may be arranged according to the actual situation, which are not limited herein. As an example, the three antenna elements may be arranged in an equilateral triangle (side length d), an isosceles right triangle (right-angled side length d), or in other types.

The operation that the observation vector corresponding to the at least three antenna elements is determined based on the UWB signals may be regarded as measuring a phase of the UWB signal received by each antenna element among the at least three antenna elements, and calculating a pairwise difference of the phases of the UWB signal received by the antenna elements to determine the observation vector corresponding to the at least three antenna elements. In practical applications, the anchor may also be called a positioning anchor, and the UWB tag may also be called a positioning tag. As an example, the positioning anchor receives the UWB signal sent by the positioning tag, measures the phases of the UWB signal received by the antenna elements, and calculating a pairwise difference of the measured phases to construct the observation vector.

For convenience of understanding, as illustrated herein, a pairwise difference of the phases of the signal received by an appropriate combination of antenna elements is calculated as one dimension of a vector. The dimension of the phase different vector corresponding to an antenna array having n elements is up to

$${C}_{n}^{2} .$$

Φᵢ represents the phase of the signal received by the ith antenna element, where i may be any one of 1, 2 and 3. All possible combinations of phase differences of these elements are described with reference to formula (1) below:

$$\vec{d Φ} = [ \begin{matrix}{Φ}_{2} - {Φ}_{1} \\ {Φ}_{3} - {Φ}_{1} \\ {Φ}_{3} - {Φ}_{2}\end{matrix} ] \qquad ( 1 )$$

The preset vector template, the theoretical azimuth angle, and the preset angle may all be determined according to the actual situation, which are not limited herein. The theoretical azimuth angle may be denoted as φ₀. The preset angle may also be referred to as a reference pitch angle and may be denoted as θ₀. As an example, a reference pitch angle θ₀ may be selected, and the phase difference vectors of the signals received by the antenna elements when the tag is at different azimuth angles are acquired through simulation or measurement, as the preset vector template. In practical applications, the preset vector template may include the theoretical azimuth angles φ₀ and the phase difference vectors \vec{dΦ} of the received signals, and there is a mapping relationship between the theoretical azimuth angles φ₀ and the phase difference vectors \vec{dΦ} of the received signals. For convenience of understanding, the preset vector template is illustratively shown in Table 1, and Table 1 is a schematic diagram of the preset vector template.

TABLE 1

| | phase difference vector |
|---|---|
| theoretical azimuth angle φ₀ | \vec{dΦ} of received signals |
| 0° | \vec{dΦ₀} |
| 1° | \vec{dΦ₁} |
| 2° | \vec{dΦ₂} |
| . . . | . . . |
| 358° | \vec{dΦ₃₅₈} |
| 359° | \vec{dΦ₃₅₉} |

The operation that the theoretical azimuth angle corresponding to the vector having the highest matching degree with the observation vector is determined according to the observation vector and the preset vector template may include following operations. The observation vector is matched with the phase difference vectors \vec{dΦ} of the received signals in the preset vector template to obtain the phase difference vector of the received signal having the highest matching degree with the observation vector. The theoretical azimuth angle corresponding to the vector having the highest matching degree with the observation vector in the preset vector template is determined according to the phase difference vector of the received signal having the highest matching degree with the observation vector. The most similar theoretical azimuth angle is determined based on the second column of the above table.

In the operation that the second angle is determined according to the theoretical azimuth angle and the preset angle, the preset vector template is searched for the vector having the best matching with the observation vector, and a difference between the vector and the observation vector is caused by the difference between a pitch angle during observation and the reference pitch angle θ₀. The pitch angle θ may be calculated based on the difference. In practical applications, the pitch angle θ is not necessary, but the positioning accuracy may be improved if the accurate pitch angle θ is known.

In an optional embodiment of the present disclosure, for each anchor 101, XYZ coordinate system is established with taking the anchor 101 as an origin and taking a normal of a shell surface of the anchor as Z-axis. The first angle is an angle between a projection of a line connecting the device 102 with the anchor onto the XOY plane in the XYZ coordinate system and X-axis, and the second angle is an angle between the distance between the device 102 and the anchor 101 and the Z-axis in the XYZ coordinate system.

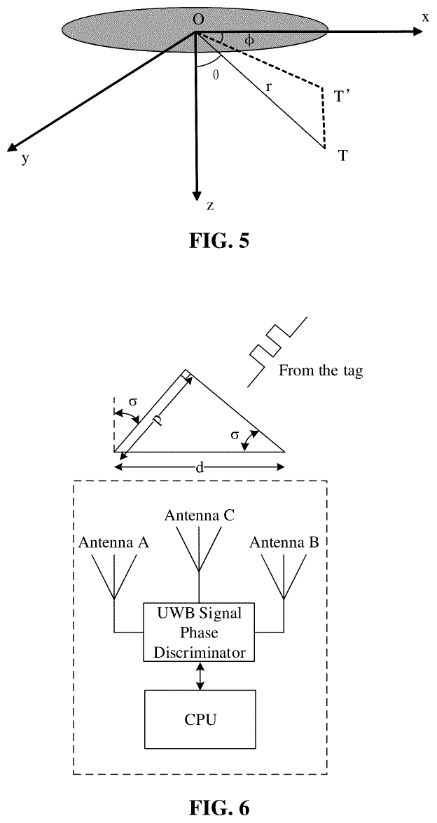

For convenience of understanding, as shown in FIG. 5, FIG. 5 is a schematic diagram of a three-dimensional coordinate system established between the anchor and the device in an embodiment of the present disclosure. The three-dimensional rectangular coordinate system is established with taking the center of the UWB anchor as the origin O and taking the normal of the shell surface of the anchor as the z-axis. The position of the device 102 is T, the length of OT is r, the angle between the projection OT′ of OT on the xOy plane and Ox is the first angle, which is also known as the azimuth angle, denoted as φ, and the angle between OT and Oz is the second angle, which is also known as the pitch angle, denoted as θ.

In an optional embodiment of the present disclosure, the coordinates of the device 102 comprise three-dimensional coordinates of the device 102.

The processor is further configured to determine the three-dimensional coordinates of the device 102 based on the first angle, the second angle and the distance between the device 102 and the anchor 101.

It should be noted that the three-dimensional coordinates of the device 102 may be denoted as (x, y, z), the first angle is denoted as φ, the second angle is denoted as θ, and the distance between the device 102 and the anchor 101 is denoted as r. The three-dimensional coordinates (x, y, z) of the device 102 may calculated with reference to the following formula (2):

$$x = r sin θcosφ \qquad ( 2 )$$

$$y = r sin θsinφ$$

$$z = r cos θ$$

In an optional embodiment of the present disclosure, the coordinates of the device 102 include two-dimensional coordinates of the device 102.

The processor is further configured to obtain a height difference between the anchor 101 and the device 102, and determine the two-dimensional coordinates of the device 102 based on the first angle, the height difference and the distance between the device 102 and the anchor 101.

It should be noted that the height difference between the anchor 101 and the device 102 may be determined according to the actual situation, or may be a preset threshold, which is not limited herein.

The height difference between the anchor 101 and the device 102 may be denoted as Z, and the two-dimensional coordinates of the device 102 may be denoted as (x, y), the first angle is denoted as q, the distance between the device 102 and the anchor 101 is denoted as r. The two-dimensional coordinates (x, y) of the device 102 may be calculated with reference to the following formula (3).

$$x = cos φ \times \sqrt{{r}^{2} - {z}^{2}} \qquad ( 3 )$$

$$y = sin φ \times \sqrt{{r}^{2} - {z}^{2}}$$

In this embodiment, assuming that the device 102 is a UWB vehicle key, the height of the UWB vehicle key from the ground does not change much in daily use, the height difference z between the UWB vehicle key and the UWB-AOA anchor does not change much accordingly. When z is known, the plane coordinates (x, y) may be approximately solved.

In an optional embodiment of the present disclosure, at least two of the spacings between any two of the three antenna elements are less than or equal to a half-wavelength of the UWB signal.

It should be noted that the wavelength of the UWB signal may be denoted as λ; the half-wavelength of the UWB signal may be denoted as

$$\frac{λ}{2} .$$

The at least two of the spacings between any two of the three antenna elements being less than or equal to the half-wavelength of the UWB signal may be regarded as at least two of the distances between any two antenna elements among the three antenna elements is less than or equal to

$$\frac{λ}{2} .$$

In an optional embodiment of the present disclosure, the UWB signal phase discriminator 1012 is further configured to determine an angle at which each pair of at least two pairs of antenna elements receive the same UWB signal. The at least two pairs of antenna elements are composed of any two antenna elements among the at least three antenna elements.

The processor is further configured to determine the first angle and/or the second angle based on the angle and a position relationship between antenna elements of each pair.

In this embodiment, any two antenna elements among the at least three antenna elements may constitute a pair of antenna elements. The angle at which the pair of at least two pairs of antenna elements receives the same UWB signal is determined, and the angle may be denoted as σ. That is, the angles σ at which the same UWB signal reaches at least two pairs of antenna elements are measured. In practical applications, there may be or may not be a common antenna element shared by the two pairs of antenna elements.

The operation that the first angle and/or the second angle is determined based on the angle and the position relationship between antenna elements in each pair may include determining the first angle and/or the second angle based on at least two angles σ and the position relationship between the antenna elements in each pair of antenna elements.

In an optional embodiment of the present disclosure, the UWB signal phase discriminator is further configured to determine a phase difference of the same UWB signal received by a pair of antenna elements, and determine an angle at which the pair of antenna elements receives the same UWB signal based on the phase difference.

It should be noted that the phase difference may be denoted as α. For convenience of understanding, an example of deriving the angle σ by using a pair of antenna elements composed of the first antenna element and the second antenna element is described herein. The first antenna element may be denoted as element A, and the second antenna element may be denoted as element B.

A distance difference of the same UWB signal which reaches element A and element B is calculated with reference to the following formula (4).

$$p = d sin σ \qquad ( 4 )$$

In formula (4), p denotes the distance difference of the same UWB signal which reaches element A and element B, d denotes a distance between element A and element B, σ denotes the angle at which the pair of antenna elements receive the same UWB signal.

The UWB signal wavelength is calculated with reference to the following formula (5).

$$λ = \frac{c}{f} \qquad ( 5 )$$

In formula (5), λ denotes the wavelength of the UWB signal, c denotes the speed of light, and f denotes the carrier frequency of the UWB signal.

The phase difference of the same UWB signal which reaches two antenna arrays is calculated with reference to the following formulas (6) and (7).

$$\frac{α}{2 π} = \frac{p}{λ} \qquad ( 6 )$$

$$that is : p = \frac{αλ}{2 π} \qquad ( 7 )$$

$$Therefore : sin σ = \frac{p}{d} = \frac{αλ}{2 π d} \qquad ( 8 )$$

$$that is : σ = arcsin \frac{αλ}{2 π d} \qquad ( 9 )$$

For convenience of understanding, three application embodiments are presented here.

The first application embodiment is described as follows.

The first application embodiment includes operations 1 to 5.
At operation 1, the positioning anchor receives the UWB signal sent by the positioning tag, measures phases of the signal received by the antenna elements, and calculate a pairwise difference of the phases to construct the observation vector.
At operation 2, a reference pitch angle θ₀ is selected, and the phase difference vectors of the signals received by the antenna elements when the flag is at different azimuth angles are acquired through simulation or measurement, as the template. Reference may be made to Table 1 regarding the template.
At operation 3, the phase difference vector template is searched for the best matching entry with the observation vector and the azimuth angle φ, that is, the second column of Table 1 is searched for the most matching row.
At operation 4, every two of the phases of the UWB signals received by the appropriate combination of antenna elements are subtracted pairwise as a dimension of the vector. For an antenna array having n elements, the maximum number of dimensions of the phase difference vectors is up to

$${C}_{n}^{2} . {Φ}_{i}$$

represents the phase of the signal received by the ith antenna element, where i may be any one of 1, 2 and 3. Regarding all possible combinations of phase differences of these elements, reference is made to formula (1) above.
At operation 5, the difference between the vector having the best matching with the observation vector searched from the phase difference vector template and the observation vector is caused by the difference between the pitch angle during observation and the reference pitch angle θ₀. The pitch angle θ may be calculated based on the above difference. The pitch angle θ is not necessary in some conditions, but the positioning accuracy can be improved if the accurate pitch angle θ is known.

The second application embodiment is described as follows.

The second application embodiment may be understood in combination with FIG. 6. FIG. 6 is another schematic structural diagram of the anchor in the embodiment of the present disclosure.
At operation 1, in FIGS. 6, A, B, and C represent three antenna elements in an antenna array of the UWB-AOA anchor that are not on the same straight line. In practice, there may be a fourth element D, or even more elements E, F and so on.
At operation 2, the angle σ of the UWB signal relative to two antenna elements may be calculated by measuring the phase difference of the same UWB signal received by the two antenna elements.
At operation 3, the angle σ is derived based on for example the two antenna elements A and B according to formulas (4), (5), (6), (7), (8), and (9) above.
At operation 4, the angles σ at which the UWB signal reaches at least two pairs of antenna elements are measured (the two pairs of antenna elements may share a common antenna element, or may not share a common antenna element).
At operation 5, the stereoscopic or planar projection direction of the UWB tag relative to the UWB-AOA anchor may be further acquired through at least two angles σ and a geometric relationship of the angles.

The third application embodiment is described as follows.

The third application embodiment includes operations 1 and 2.
At operation 1, a ranging process is performed.

The antenna array of the anchor and the tag to be positioned performs ranging in real time through the UWB signal, and the accuracy of the ranging can reach 10 cm. Because the clocks of the anchor and the tag are not synchronized, the two-way ranging (TWR) algorithm is usually used to obtain the distance r.
At operation 2, the positioning coordinates (x, y, z) are calculated with reference to formula (2) above (transformation between the spherical coordinate system and the rectangular coordinate system).

If assumed that the height of the UWB vehicle key from the ground does not change much in daily use, the height difference z between the UWB vehicle key and the UWB-AOA anchor does not change much accordingly. When z is known, the plane coordinates (x, y) can be approximately solved, and the varying r sin θ is replaced with the fixed \sqrt{r²−z²}, referring to formula (3) above.

In practice, obtaining only the two-dimensional coordinates (x, y) of the UWB tag (vehicle key) can meet the position requirements of the UWB vehicle key in most scenarios.

In the positioning system provided by the embodiment of the present disclosure, for each anchor in the at least one anchor, the anchor receives the UWB signal sent by the device provided with the UWB tag, determines the orientation parameter of the device and the anchor according to the UWB signal, and positions the device based on the orientation parameter and the distance between the device and the anchor, thereby realizing accurate positioning and reducing the number and cost of the anchors.

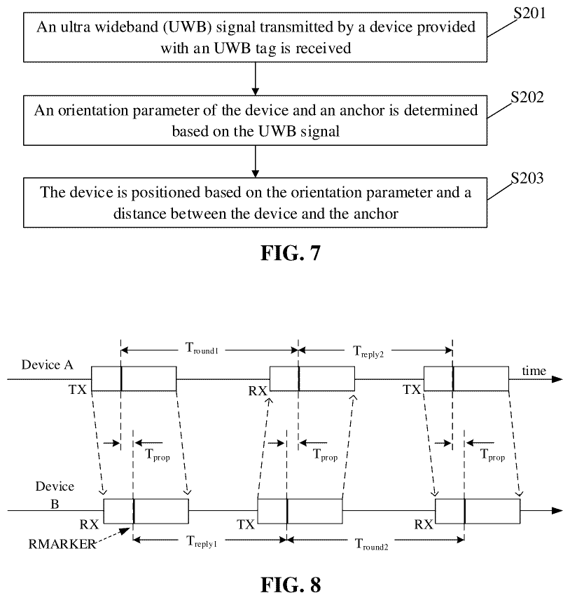

Based on the above-mentioned positioning system 100, the embodiment of the present disclosure further provides a positioning method, which is applied to the above-mentioned positioning system 100. FIG. 7 is a schematic implementation flowchart of the positioning method in the embodiment of the present disclosure. As shown in FIG. 7, the method includes the following operations 201 to 203.
At operation S201, an ultra wideband (UWB) signal transmitted by a device provided with an UWB tag is received.
At operation S202, an orientation parameter of the device and an anchor is determined based on the UWB signal.
At operation S203, the device is positioned based on the orientation parameter and a distance between the device and the anchor.

It should be noted that the embodiment may be performed by the anchor. The device may be determined according to the actual situation, which is not limited herein. As an example, the device may be a network device, a terminal device, a handheld device, etc. In practical applications, the device may specifically be a physical key or a mobile phone, and the physical key may be a physical vehicle key.

The orientation parameter may be determined according to the actual situation, which is not limited herein. As an example, the orientation parameter may be regarded as the stereoscopic or planar projection direction. In practical applications, the anchor may receive the UWB signal, and the UWB signal may be used to measure the stereoscopic or planar projection direction of the device and the anchor.

The distance between the device and the anchor may be the distance between the device and the anchor, and the distance may be determined according to the actual situation, which is not limited herein. As an example, the distance between the device and the anchor may be determined based on the time of flight (TOF).

The operation that the device is positioned based on the orientation parameter and a distance between the device and the anchor may include determining the coordinates of the device based on the orientation parameter and the distance between the device and the anchor. The coordinates may include three-dimensional coordinates or two-dimensional coordinates.

In an optional embodiment of the present disclosure, the orientation parameter includes a first angle and/or a second angle, and the operation that the orientation parameter of the device and the anchor is determined based on the UWB signal includes the following operation.

The first angle and/or the second angle of the device and the anchor is determined based on the UWB signal.

It should be noted that the first angle may be denoted as φ, or may also be known as the azimuth angle. The first angle may characterize an angle formed by the planar projection of the distance between the device and the anchor. The second angle may be denoted as θ, or may also be known as the pitch angle. The second angle may characterize an angle between the distance between the device and the anchor and the normal of a shell surface of the anchor. In practical applications, the distance between the device and the anchor may be regarded as a straight line connecting the device and the anchor, the length of the line is referred to as the distance, and the line connecting the device and the anchor may be denoted as OT, and the length of OT may be denoted as r.

In an optional embodiment of the present disclosure, the operation that the device is positioned based on the orientation parameter and a distance between the device and the anchor further includes the following operations.

The coordinates of the device are determined based on the first angle and/or the second angle and the distance between the device and the anchor.

It should be noted that the coordinates of the device may include three-dimensional coordinates or two-dimensional coordinates. The three-dimensional coordinates may be denoted as (x, y, z), and the two-dimensional coordinates may be denoted as (x, y).

In an optional embodiment of the present disclosure, the coordinates of the device include the three-dimensional coordinates of the device, and the method further includes the following operation.

The three-dimensional coordinates of the device are determined based on the first angle, the second angle, and the distance between the device and the anchor.

It should be noted that the three-dimensional coordinates of the device may be denoted as (x, y, z), the first angle is denoted as φ, and the second angle is denoted as θ, and the distance between the device and the anchor is denoted as r. The three-dimensional coordinates (x, y, z) of the device may be calculated with referring to formula (2) above.

In an optional embodiment of the present disclosure, the coordinates of the device include two-dimensional coordinates of the device, and the method further includes the following operation.

A height difference between the device and the anchor is obtained, and the two-dimensional coordinates of the device are determined based on the first angle, the height difference and the distance between the device and the anchor.

It should be noted that the height difference between the anchor and the device may be determined according to the actual situation, or may be a preset threshold, which is not limited herein.

The height difference between the anchor and the device may be denoted as Z, the two-dimensional coordinates of the device 102 may be denoted as (x, y), the first angle is denoted as φ, and the distance between the device and the anchor is denoted as r. The two-dimensional coordinates (x, y) of the device 102 may be calculated with reference to formula (3) above.

In an optional embodiment of the present disclosure, the distance between the device and the anchor is determined based on the TOF corresponding to the UWB signal.

For convenience of understanding, an example is illustrated, as shown in FIG. 8, FIG. 8 is a schematic diagram of ranging through UWB signal in the embodiment of the present disclosure, in which Tₚᵣₒₚ denotes the flight time of receiving and transmitting the UWB signal between the UWB tag and the UWB anchor.

The distance between the UWB tag and the UWB anchor is calculated with reference to the formula (10).

$$D = c \times {T}_{prop} \qquad ( 10 )$$

$${T}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )}$$

In formula (10), a transmission speed of the UWB signal is equal to the speed c of light.

In the embodiments of the present disclosure, the UWB anchor and device perform real-time ranging through the UWB signal, and the accuracy of the ranging can reach 10 cm. Since the clocks of the UWB anchor and device are not synchronized, the TWR algorithm is actually used.

The embodiments of the present disclosure also provide a computer-readable medium on which a computer program is stored. The computer program, when executed by a processor, implements the operations of the above method embodiments. The aforementioned storage medium includes a mobile storage device, a read-only memory (ROM), a random access memory (RAM), a magnetic disk, or an optical disc and other various media that is able to store program codes.

The method operations in the above system of the embodiments of the present disclosure may be stored in the computer-readable storage medium when the method operations are implemented in the form of software functional modules and sold or used as a stand-alone product. Based on such understanding, an essential part of the technical solutions of the embodiments of the present disclosure or parts of the technical solutions that contribute to the prior art can be embodied in the form of software products, and the computer software product is stored in a storage medium. The aforementioned storage medium includes a USB flash disk, a mobile hard disk, a read-only memory (ROM), a magnetic disk, or an optical disc and other various media that can store program codes. In this way, the embodiments of the present disclosure are not limited to any specific combination of hardware and software.

A person of ordinary skill in the field may understand that all or part of the operations for implementing the above-mentioned method embodiment may be implemented by instructing related hardware by a program, the above-mentioned program may be stored in a computer-readable storage medium. When the program is executed, the operations included in the above-mentioned method embodiment are executed. The above storage medium includes a mobile storage device, a ROM, a RAM, a magnetic disk or an optical disk, and other media capable of storing program codes.

The methods disclosed in the above embodiments of the present disclosure can be applied to a processor or implemented by a processor. The processor may be an integrated circuit chip, and has a signal processing function. The operations of the method disclosed in conjunction with the embodiments of the present disclosure may be directly executed and implemented by a hardware decoding processor, or by combining hardware and software modules in the decoding processor. The software module may be located in a storage medium in a memory, and the processor reads information in the memory and implements the operations of the foregoing method in conjunction with its hardware.

Only implementations of the present disclosure are described above, but the protection scope of the present disclosure is not limited thereto. Changes or substitutions easily conceived by any skilled person in the technical field disclosed in the embodiments of the present disclosure fall within the protection scope of the present disclosure. Therefore, the protection scope of the present disclosure shall be subject to the protection scope of the said claims.

### INDUSTRIAL APPLICABILITY

With the technical solutions of the embodiments of the present disclosure, each anchor in at least one anchor receives the UWB signal sent by the device provided with an ultra wideband (UWB) tag, determines the orientation parameter of the device and the anchor according to the UWB signal, and positions the device based on the orientation parameter and the distance between the device and the anchor, thereby achieving accurate positioning and reducing the number and cost of anchors.

1. A positioning system, comprising:
at least one anchor provided in a vehicle; and
a device provided with an ultra wideband (UWB) tag,
wherein the device is configured to send a UWB signal; and
for each anchor of the at least one anchor, the anchor is configured to receive the UWB signal, determine an orientation parameter of the device and the anchor according to the UWB signal, and position the device based on the orientation parameter and a distance between the device and the anchor,
wherein the orientation parameter comprises a first angle and/or a second angle, each of the at least one anchor comprises a UWB antenna array, a UWB signal phase discriminator and a processor, wherein each of the UWB antenna array and the processor is connected to the UWB signal phase discriminator,
the UWB antenna array is configured to receive the UWB signal;
the UWB signal phase discriminator is configured to determine a phase parameter of the UWB antenna array based on the UWB signal; and
the processor is configured to determine the first angle and/or the second angle of the device and the anchor based on the phase parameter, and determine coordinates of the device based on the first angle and/or the second angle, and the distance between the device and the anchor,
wherein the UWB antenna array comprises at least three antenna elements, the three antenna elements are not arranged on a same straight line, and each antenna element of the at least three antenna elements is connected to the UWB signal phase discriminator;
each antenna element of the at least three antenna elements is configured to receive the UWB signal;
the UWB signal phase discriminator is further configured to determine an observation vector corresponding to the at least three antenna elements based on the UWB signal, wherein an element in the observation vector represents a phase difference of the UWB signal received by every two antenna elements among the at least three antenna elements; and
the processor is further configured to determine a theoretical azimuth corresponding to a vector having the highest matching degree with the observation vector based on the observation vector and a preset vector template, and take the theoretical azimuth as the first angle, and/or determine the second angle based on the theoretical azimuth and a preset angle,
the coordinates of the device comprise two-dimensional coordinates of the device, and
the processor is further configured to obtain a height difference between the anchor and the device, and determine the two-dimensional coordinates of the device based on the first angle, the height difference, and the distance between the device and the anchor.

2. The system of claim 1, wherein for each of the at least one anchor, an XYZ coordinate system is established with taking the anchor as an origin and taking a normal of a shell surface of the anchor as Z-axis, the first angle is an angle between a projection of a distance between the device and the anchor onto an XOY plane in the XYZ coordinate system and an X-axis, and the second angle is an angle between the distance between the device and the anchor and the Z-axis in the XYZ coordinate system.

3. The system of claim 1, wherein the coordinates of the device comprise three-dimensional coordinates of the device, and
the processor is further configured to determine the three-dimensional coordinates of the device based on the first angle, the second angle, and the distance between the device and the anchor.

4. The system of claim 1, wherein at least two of spacings between any two of the three antenna elements are less than or equal to a half-wavelength of the UWB signal.

5. The system of claim 1, wherein
the UWB signal phase discriminator is further configured to determine an angle at which each pair of at least two pairs of antenna elements receives a same UWB signal, wherein the at least two pairs of antenna elements are composed of any two antenna elements among the at least three antenna elements; and
the processor is further configured to determine the first angle and/or the second angle based on the angle and a position relationship between antenna elements in each pair of antenna elements.

6. The system of claim 5, wherein
the UWB signal phase discriminator is further configured to, for each pair of antenna elements, determine a phase difference of the same UWB signal received by the pair of antenna elements, and determine an angle at which the pair of antenna elements receive the same UWB signal based on the phase difference.

7. A positioning method applied to the positioning system according to claim 1, comprising:
receiving an ultra wideband (UWB) signal transmitted by a device provided with an UWB tag;
determining an orientation parameter of the device and an anchor according to the UWB signal; and
positioning the device based on the orientation parameter and a distance between the device and the anchor,
wherein the orientation parameter comprises a first angle and/or a second angle, and the determining the orientation parameter of the device and the anchor according to the UWB signal comprises:
determining the first angle and/or the second angle of the device and the anchor according to the UWB signal,
wherein the positioning the device based on the orientation parameter and a distance between the device and the anchor comprises:
determining coordinates of the device based on the first angle and/or the second angle, and the distance between the device and the anchor,
wherein the coordinates of the device comprise two-dimensional coordinates of the device, and the method further comprises:
acquiring a height difference between the device and the anchor, and determining the two-dimensional coordinates of the device based on the first angle, the height difference, and the distance between the device and the anchor.

8. The method of claim 7, wherein the coordinates of the device comprise three-dimensional coordinates of the device, and the method further comprises:
determining the three-dimensional coordinates of the device based on the first angle, the second angle, and the distance between the device and the anchor.

9. The method of claim 7, wherein the distance between the device and the anchor is determined based on time of flight (TOF) corresponding to the UWB signal.

10. A non-transitory computer-readable storage medium on which a computer program is stored, wherein the computer program, when executed by a processor, implements:
receiving an ultra wideband (UWB) signal transmitted by a device provided with an UWB tag;
determining an orientation parameter of the device and an anchor according to the UWB signal; and
positioning the device based on the orientation parameter and a distance between the device and the anchor,
wherein the orientation parameter comprises a first angle and/or a second angle, and the computer program, when executed by a processor, implements:
determining the first angle and/or the second angle of the device and the anchor according to the UWB signal,
wherein the computer program, when executed by a processor, implements:
determining coordinates of the device based on the first angle and/or the second angle, and the distance between the device and the anchor,
wherein the coordinates of the device comprise two-dimensional coordinates of the device, and the computer program, when executed by a processor, implements:
acquiring a height difference between the device and the anchor, and determining the two-dimensional coordinates of the device based on the first angle, the height difference, and the distance between the device and the anchor.

11. The system of claim 1, wherein the at least one anchor is an ultra wideband-angle of arrival (UWB-AOA) anchor arranged on the vehicle, and the device is a UWB vehicle key.

12. The method of claim 7, wherein the anchor is an ultra wideband-angle of arrival (UWB-AOA) anchor arranged on a vehicle, and the device is a UWB vehicle key.

13. The non-transitory computer-readable storage medium of claim 10, wherein the coordinates of the device comprise three-dimensional coordinates of the device, and the computer program, when executed by a processor, implements:
determining the three-dimensional coordinates of the device based on the first angle, the second angle, and the distance between the device and the anchor.

14. The non-transitory computer-readable storage medium of claim 10, wherein the distance between the device and the anchor is determined based on time of flight (TOF) corresponding to the UWB signal.
